(19) United States
(12) Patent Application Publication
(10) Pub. No.: US 2003/0182913 A1
(43) Pub. Date: Oct. 2, 2003

(54) Device to reduce lawn edging

(76) Inventor: David L. Wittschen, Ladson, SC (US)

Correspondence Address: David L. Wittschen, 226 Loblolly Circle, Ladson, SC, 29456, US

(21) Appl. No.: 10/095,867

(22) Filed: Mar. 12, 2002

(51) Int. Cl. A01D 34/00

(52) U.S. Cl. 56/17.3

(57) ABSTRACT

An angled extension is added to a lawnmower which diverts the grass besides the walls and other objects under the housing and into the cutting area. This improves the cutting area of the mower and potentially eliminates a secondary trimming operation.

### CROSS-REFERENCE TO RELATED APPLICATIONS

Not Applicable.

### FEDERALLY SPONSORED RESEARCH

Not Applicable.

### MICROFICHE APPENDIX

Not Applicable.

### BACKGROUND OF THE INVENTION:

This device relates to lawnmowers.

A lawn usually contains house walls, fences, trees, and other upright objects. The lawnmower does not cut all the way to the upright object, but leaves an uncut area which has to be secondarily trimmed out by tools such as weedeaters. The width of the uncut area is roughly equal to the gap between the outside tip of the blade and the inside of the housing plus the thickness of the housing. The wheels are usually inset to the housing in a manner not to make the situation worse.

### SUMMARY OF THE INVENTION

The invention is an article of manufacture, which when combined with a lawnmower, reduces or eliminates the need for a secondary edge trimming around upright objects in the yard. This article of manufacture, or device, can be built in at the factory or added to an existing mower as an accessory item.

The device is basically an angled extension attached to the outer-most section of the housing. The tip of the device separates the grass from the upright objects. Then, the angle of the device forces the grass to slide under the housing, and enter the blade cutting area. In essence, the grass is bent and led into the cutting area. Since an angle is involved, the lawn cut this way will taper higher as it approaches the upright object. However, this effect is minimal as the grass is only moved about ½″ sideways. The final appearance is acceptable when compared to the effort of a secondary trimming operation.

### DESCRIPTION OF THE DRAWINGS

FIG. 1 is a top view showing the device besides an upright object, or wall.

FIG. 2 is a side view showing the attached device as it diverts grass under the lawnmower housing and into the cutting area.

FIG. 3 is an isometric drawing of the device itself before attachment.

### DESCRIPTION OF THE INVENTION

The prototype was made from formed and welded metal. However, the product can be made from any rigid or semi-rigid material.

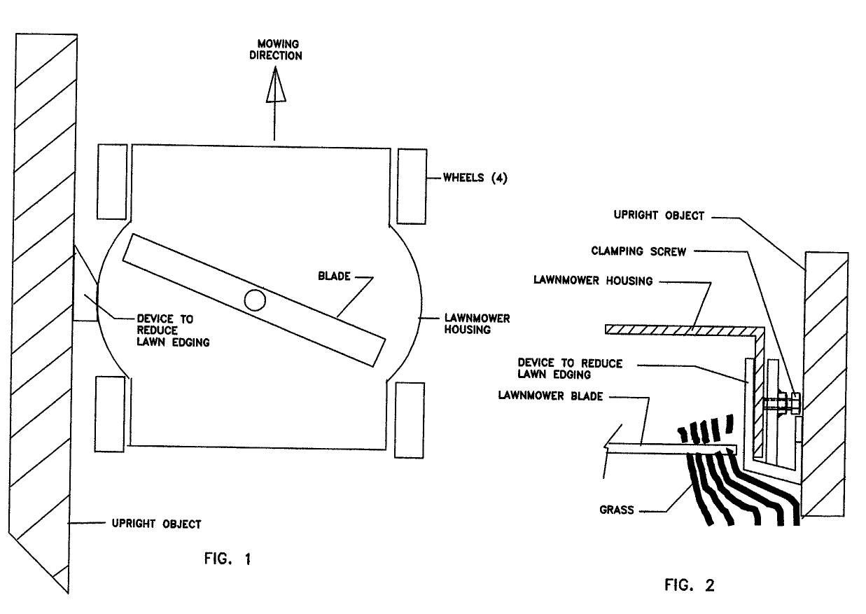

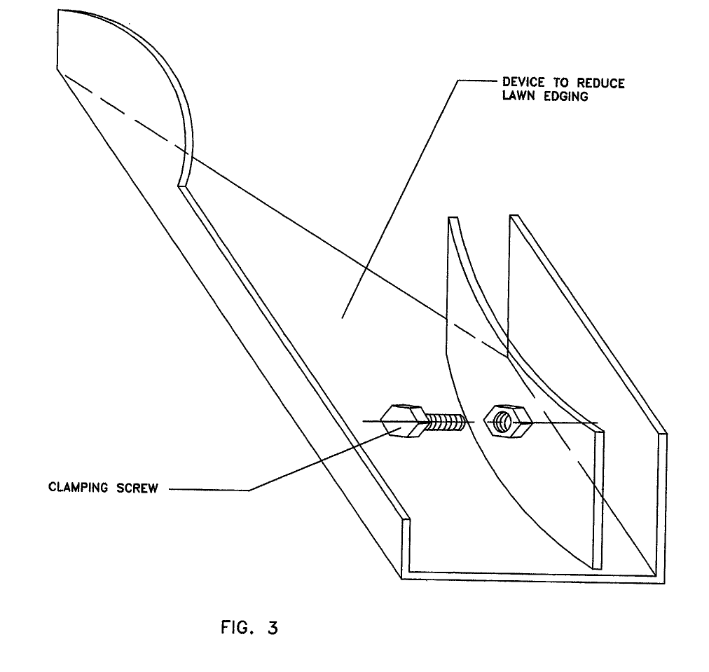

The process to use the device is as follows. The device shown in FIG. 3 is slipped onto the lawnmower housing as shown in FIG. 2. It is aligned such that the outside surface is parallel to both the lawnmower wheels and an upright object such as a straight wall. Then, the clamping screw shown in FIG. 2 is tightened.

To operate, the outside surface of the device is guided along the upright object as closely as possible.

I claim:

1. an article of manufacture which when added to a lawnmower reduces the amount of uncut lawn next to an upright object.
